(19) United States
(12) Patent Application Publication
(10) Pub. No.: US 2012/0151912 A1
(43) Pub. Date: Jun. 21, 2012

(54) HEAT ENGINE REGENERATOR AND STIRLING ENGINE USING THE REGENERATOR

(75) Inventors: Seiji Yamashita, Kobe-shi (JP); Shinsuke Yamaguchi, Kobe-shi (JP); Kenichi Maeda, Kobe-shi (JP)

(73) Assignee: KAWASAKI JUKOGYO KABUSHIKI KAISHA, KOBE-SHI, HYOGO (JP)

(21) Appl. No.: 13/381,543

(22) PCT Filed: Jul. 8, 2010
(86) PCT No.: PCT/JP2010/004448

§ 371 Date: Mar. 6, 2012

(30) Foreign Application Priority Data
Jul. 10, 2009 (JP) 2009-163305

(51) Int. Cl. F02G 1/057

(52) U.S. Cl. 60/520; 60/526; 62/6

(57) ABSTRACT

A regenerator, for use in a heat engine, configured to receive and store heat from a high-temperature gas flowing from a high-temperature space into the regenerator, and to provide the heat to a low-temperature fluid flowing from a low-temperature space into the regenerator. The regenerator includes a large number of layered metal meshes. Each metal mesh includes a large number of mutually parallel longitudinal strands and a large number of mutually parallel lateral strands perpendicular to the longitudinal strands. The metal meshes are layered such that each metal mesh is sequentially rotated in a same direction by a fixed angle with respect to an immediately previously layered metal mesh.

### TECHNICAL FIELD

The present invention relates to a heat engine regenerator and a Stirling engine using the regenerator. More particularly, the present invention relates to a regenerator that is used in a heat engine such as a Stirling engine in order to provide and receive enthalpy to and from a working fluid, and relates to a Stirling engine using the regenerator.

### BACKGROUND ART

Conventionally, regenerators are used as heat exchangers in, for example, Stirling engines and boilers for thermal power generation. Such a regenerator receives a part of enthalpy of a high-temperature fluid from the high-temperature fluid and stores the received enthalpy, and provides part of the stored enthalpy to a low-temperature fluid.

Patent Literature 1 discloses a so-called β-type (single cylinder/displacer type) Stirling engine, which is one example of the aforementioned Stirling engine. A β-type Stirling engine includes: a piston for use in varying a volume ratio between a high-temperature side work space (hereinafter, referred to as an expansion space) and a low-temperature side work space (hereinafter, referred to as a compression space) within a single cylinder (hereinafter, this piston is referred to as a displacer); and a piston for use in varying the volume of the entire work space (hereinafter, this piston is referred to as an output piston or a power piston).

In the Stirling engine disclosed in Patent Literature 1, a fluid passage through which the expansion space and the compression space communicate with each other is formed around the outer periphery of the cylinder. An upper part of the fluid passage is a part of a heating section which includes heating means, and a lower part of the fluid passage is a part of a cooling section which includes cooling means. A regenerator is provided between the heating section and the cooling section. The regenerator is in a cylindrical shape and has space formed at its center. The cylinder is disposed in the space. This type of regenerator is called an annular regenerator.

During an operation of the Stirling engine, a working fluid such as helium moves between the expansion space and the compression space through the heating section, the regenerator, and the cooling section in a reciprocating manner. When the working fluid moves from the expansion space to the compression space, the regenerator receives enthalpy from a high-temperature fluid, i.e., the working fluid that has passed through the heating section and of which the temperature has been increased, and stores the received enthalpy. On the other hand, when the working fluid moves from the compression space to the expansion space, the regenerator radiates heat and provides the heat to a low-temperature fluid, i.e., the working fluid that has passed through the cooling section and of which the temperature has been reduced. Owing to the reciprocating movement of the working fluid, the displacer and the power piston move in a reciprocating manner with a constant phase difference therebetween. Power is extracted via separate drive rods (output rods), which are a drive rode connected to the displacer and a drive rod connected to the power piston.

Here, various types of regenerators are employable. Due to functions required for regenerators, a metallic porous body that is excellent in terms of air permeability and thermal conductivity is often used in a regenerator. In particular, a large number of layered metallic meshes are used. Such layered metallic meshes are used also in the regenerator of the Stirling engine disclosed in Patent Literature 1. Each metallic mesh is formed of a large number of mutually parallel longitudinal strands and a large number of mutually parallel lateral strands perpendicular to the longitudinal strands. In both the longitudinal strands and the lateral strands, each strand is spaced apart from the other with a substantially consistent pitch.

Conventionally, various attempts have been made aiming at improving the performance of regenerators (see Patent Literature 2, Patent Literature 3, and Patent Literature 4). However, in relation to layering metallic meshes for use in a regenerator, there have been no special findings made regarding a mesh strand direction. For example, none of these Patent Literatures disclose specific rules, general practice, and past records that refer to unifying a mesh strand direction among multiple metallic meshes.

### CITATION LIST

### Patent Literature

PLT 1: Japanese Laid-Open Patent Application Publication No. H06-294349

PLT 2: Japanese Laid-Open Patent Application Publication No. H10-227255

PLT 3: Japanese Laid-Open Patent Application Publication No. 2007-270789

PLT 4: Japanese Laid-Open Patent Application Publication No. H07-260380

### SUMMARY OF INVENTION

An object of the present invention is to provide a heat engine regenerator with improved performance that is realized even with use of conventional publicly known metallic meshes and with no necessity of adding other components to the regenerator, and to provide a Stirling engine using the regenerator.

A heat engine regenerator according to the present invention for use in a heat engine is configured to receive and store heat from a high-temperature gas flowing from a high-temperature space into the heat engine regenerator, and to provide the heat to a low-temperature fluid flowing from a low-temperature space into the heat engine regenerator. The heat engine regenerator includes a large number of layered metallic meshes. Each metallic mesh includes a large number of mutually parallel longitudinal strands and a large number of mutually parallel lateral strands perpendicular to the longitudinal strands. The metallic meshes are layered such that each metallic mesh is sequentially rotated in a same direction by a fixed angle with respect to an immediately previously layered metal mesh.

According to the above configuration, in the heat engine regenerator of the present invention, a fluid passage including complex paths is formed in a manner to extend through a metallic mesh layered body. As a result, frictional resistance exerted on a fluid passing through the layered body, that is, a fluid frictional coefficient, is reduced.

In the heat engine regenerator, each metallic mesh is preferably round-shaped or annular-shaped.

In the heat engine regenerator, it is preferred that the metallic meshes are layered such that the longitudinal strands of adjacent metallic meshes that are arranged one above another cross each other and the lateral strands of the adjacent metallic meshes that are arranged one above another cross each other.

In the heat engine regenerator, the angle may be selected in a range from 10 to 80 degrees.

In the heat engine regenerator, the angle may be selected in a range from 30 to 60 degrees.

In the heat engine regenerator, the angle may be one of 30 degrees, 45 degrees, and 60 degrees.

A Stirling engine according to the present invention includes: an expansion space for a working fluid; a compression space for the working fluid; pistons with which the expansion space and the compression space are demarcated; and a regenerator provided in a fluid passage through which the expansion space and the compression space communicate with each other. The regenerator is one of the above-described heat engine regenerators.

Since the Stirling engine includes a regenerator according to the present invention as described above, a reduction in fluid frictional coefficient is realized, which is an excellent operational advantage of the present invention. As a result, engine efficiency of the Stirling engine is improved.

### ADVANTAGEOUS EFFECTS OF INVENTION

According to the heat engine regenerator of the present invention, a passage resistance against a working fluid is reduced even with use of a conventional publicly known metallic mesh material and with no necessity of adding other components to the regenerator. As a result, regeneration efficiency of the heat engine regenerator is improved. Consequently, engine efficiency of a heat engine using the regenerator is improved.

### BRIEF DESCRIPTION OF DRAWINGS

FIG. 1 is a longitudinal sectional view showing an embodiment of a Stirling engine in which a regenerator according to the present invention is applied.

FIG. 2 is a perspective view showing a metal mesh layered body, which is a filling component of the regenerator in the Stirling engine of FIG. 1.

FIG. 3A is a plan view showing an enlarged part of the metallic mesh layered body included in the regenerator.

FIG. 3B is a cross-sectional side view along line B-B in FIG. 3A.

FIG. 3C is a cross-sectional front view along line C-C in FIG. 3A.

FIGS. 4A to 4C show the same portion of respective metal meshes that are layered such that each metal mesh is sequentially rotated in the same direction by 30 degrees with respect to an immediately previously layered metal mesh, and FIG. 4A is a plan view showing a 3n-2th (e.g., first) metal mesh, in which n is a positive integer, the minimum value of which is 1.

FIG. 4B is a plan view showing a 3n-1th (e.g., second) metal mesh, which is layered on the metal mesh shown in FIG. 4A.

FIG. 4C is a plan view showing a 3nth (e.g., third) metal mesh layered on the metal mesh shown in FIG. 4B.

FIG. 5 is a graph regarding a plurality of regenerators which are different from each other in terms of orientations of layered metallic meshes, the graph showing, in order, fluid frictional coefficients of the regenerators in relation to Reynolds numbers.

FIG. 6 is a graph showing a comparison of energy efficiencies of Stirling engines in which regenerators according to the embodiment of the present invention are used, with engine efficiencies of Stirling engines in which regenerators according to comparative examples are used.

### DESCRIPTION OF EMBODIMENTS

Hereinafter, an embodiment of a regenerator and an embodiment of a Stirling engine using the regenerator, according to the present invention, will be described with reference to the drawings.

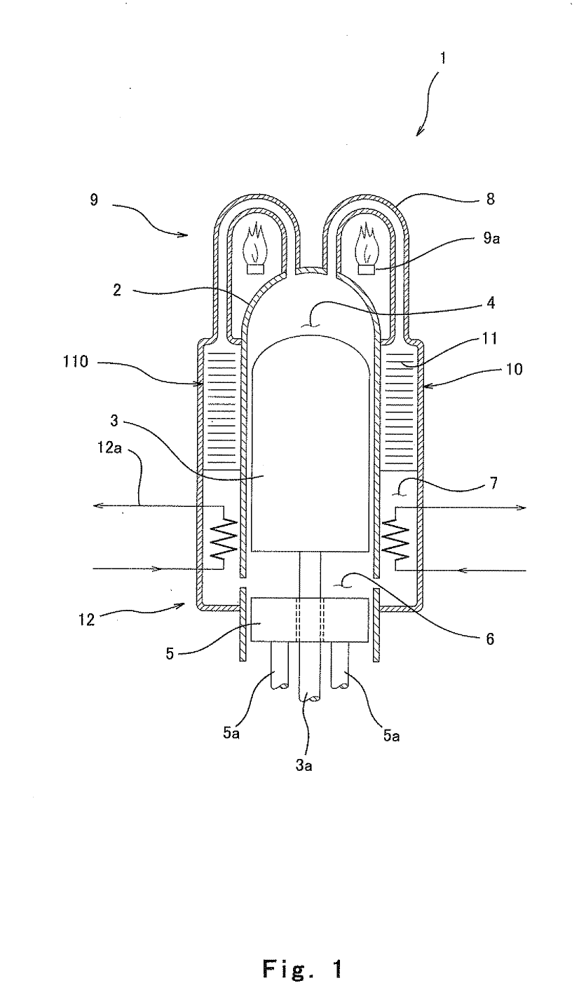

A Stirling engine 1 shown in FIG. 1 is a so-called β-type Stirling engine, which is similar to the one described in Background Art. Specifically, the Stirling engine 1 includes an expansion space 4 which is formed in an upper part of a single cylinder 2 by being partitioned off with a slidable displacer 3, and a compression space 6 which is formed in a lower part of the single cylinder 2 by being demarcated with the displacer 3 and a power piston 5. A displacer rod 3a is attached to the displacer 3 in a manner to extend through the power piston 5. Output rods 5a are attached to the power piston 5. The output rods 5a are unique to the power piston 5. The displacer rod 3a and the output rods 5a are connected to, for example, a crank shaft (not shown). The displacer 3 and the power piston 5 move in a reciprocating manner with a constant phase difference therebetween. As a result, the crank shaft connected to the displacer rod 3a and the output rods 5a is rotated.

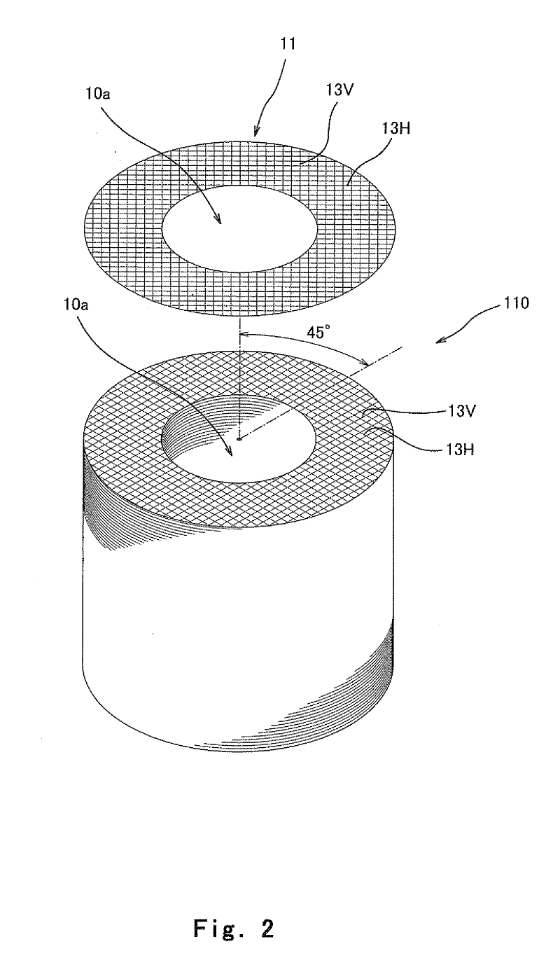

A chamber 7, in which a fluid flows, is formed around the outer periphery of the cylinder 2. A pipe 8, through which the expansion space 4 communicates with the chamber 7, is provided at the top end of the cylinder 2. A heater 9a for use in heating a working fluid such as helium within the pipe 8 is disposed at a position in proximity to the pipe 8. The pipe 8 and the heater 9a form a heating section 9. An upper internal part of the chamber 7 is filled with a layered body 110 of metallic meshes (hereinafter, referred to as “metal meshes”) 11, which is a filling component of a regenerator 10. The regenerator 10 is an annular regenerator having hollow space 10a (see FIG. 2) at its center. The cylinder 2 is disposed in the hollow space 10a. In the chamber 7, a cooling section 12 is formed below the regenerator 10. A cooling liquid 12a circulates within the cooling section 12. The cooling section 12 communicates with the compression space 6.

When the displacer 3 descends, the compression space 6 is compressed, accordingly. As a result, a low-temperature working fluid within the compression space 6 flows through the cooling section 12. Then, the working fluid receives heat at the regenerator 10 and thereby the temperature of the working fluid is increased. Thereafter, the working fluid is further heated up at the heating section 9. The working fluid, which is thus heated up and thereby expanded, is sent into the expansion space 4. The displacer 3 ascends after reaching the bottom dead center. As a result, the high-temperature working fluid within the expansion space 4 flows through the heating section 9 and reaches the regenerator 10 where the layered body 110 of the metal meshes 11 receives enthalpy from the high-temperature working fluid and stores the received enthalpy. In this manner, the working fluid is cooled down at the regenerator 10. The working fluid is further cooled down at the cooling section, and then flows into the compression space 6.

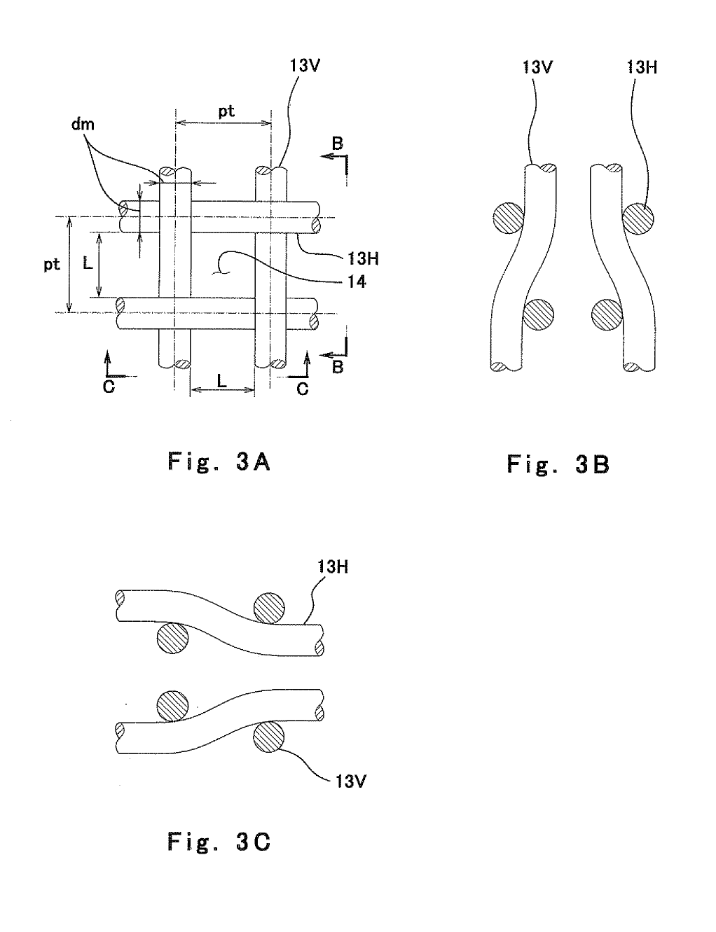

FIG. 2 shows the layered body 110 of annular metal meshes 11, which is a filling component of the regenerator 10. Depending on the shape of space in the regenerator 10, into which the metal meshes 11 are filled, the metal meshes 11 may be formed in a round shape. Each metal mesh 11 is formed of a large number of mutually parallel longitudinal strands 13V and a large number of mutually parallel lateral strands 13H perpendicular to the longitudinal strands 13V. As is clear from FIGS. 2 and 3A, in both the longitudinal strands and the lateral strands, each strand is spaced apart from the other with a substantially consistent pitch. Accordingly, the longitudinal strands 13V and the lateral strands 13H form square openings 14. Each metal mesh 11 is formed by plain weaving the strands, each of which has an external diameter dm of approximately 0.05 to 0.2 mm, with a pitch Pt which is approximately 2.5 times greater than the strand diameter. It should be understood that the pitch dimension is not limited to this.

The metal meshes 11 are layered in the following manner: with respect to a strand direction of a metal mesh 11 that is first placed for the mesh layering, the other metal meshes 11 to be layered thereon are rotated such that each metal mesh is sequentially rotated in the same direction by a fixed angle with respect to an immediately previously layered metal mesh 11. Specifically, in the case of the layered body 110 shown in FIG. 2, first and second metal meshes are layered with reference to the longitudinal strands of the first metal mesh in the following manner: the second metal mesh is layered on the first metal mesh such that the direction of the longitudinal strands of the second metal mesh is rotated by 45 degrees from the direction of the longitudinal strands of the first metal mesh. Similarly, the third metal mesh is layered on the second metal mesh such that the third metal mesh is also rotated in the same rotational direction by 45 degrees with respect to the longitudinal strands of the second metal mesh. It should be understood that the rotational center of each metal mesh is the center of the metal mesh. The rotation angle is not limited to 45 degrees but may be, for example, 30 degrees, 60 degrees, or another angle. However, the present embodiment does not include 90 degrees as the rotation angle, because the longitudinal strands 13V and the lateral strands 13H are perpendicular to each other and making a 90-degree rotation is substantially the same as no rotation being made.

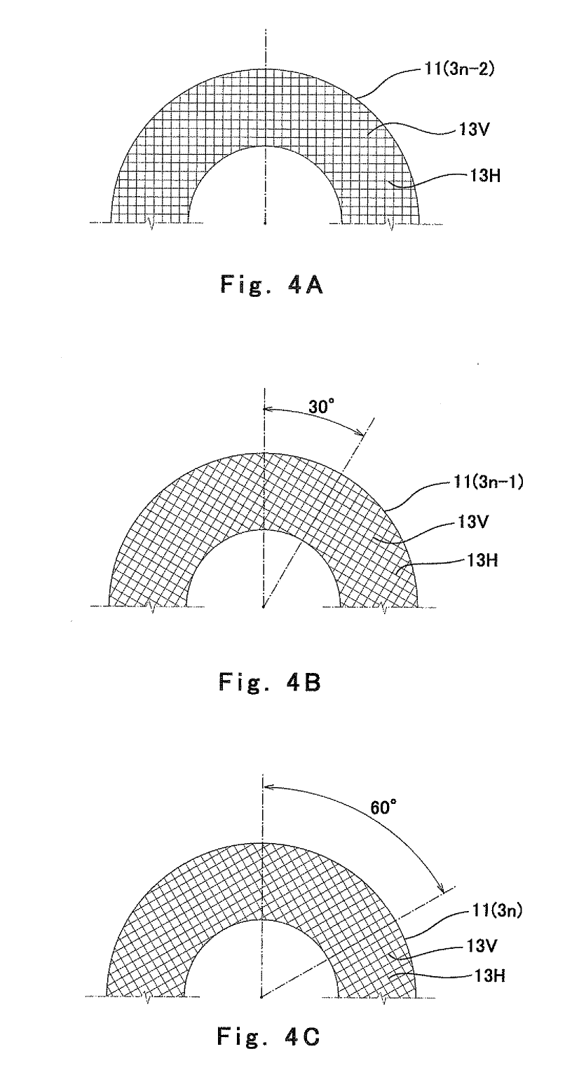

FIGS. 4A, 4B, and 4C show the same portion of respective metal meshes 11 that are layered such that each metal mesh 11 is sequentially rotated in the same direction by 30 degrees with respect to an immediately previously layered metal mesh 11. FIG. 4A is a 3n-2th (e.g., first) metal mesh 11; FIG. 4B is a 3n-1th (e.g., second) metal mesh 11; and FIG. 4C is a 3nth (e.g., third) metal mesh. Here, n is a positive integer, the minimum value of which is 1. The metal meshes 11 are layered with respective strand directions as shown in FIGS. 4A, 4B, and 4C. It should be noted that when seen in plan view, a layered body in which each metal mesh 11 is sequentially rotated in the same direction by 30 degrees with respect to an immediately previously layered metal mesh 11 appears to be the same as a layered body in which each metal mesh 11 is sequentially rotated in the same direction by 60 degrees with respect to an immediately previously layered metal mesh 11. However, a manner in which the strands 13V and 13H are layered and a manner in which the openings 14 overlap one above another are different between these two cases when seen three dimensionally. The same is true in the case of comparing, for example, a 15-degree rotation and a 75-degree rotation. In other words, a layered body with the rotation of α degrees, and a layered body with the rotation of (90-α) degrees, are different in terms of the shape of a working fluid passage. The passage is formed mainly from the openings 14 of a large number of metal meshes, the openings 14 at least partially overlap one above another. The angle α degrees herein is greater than or equal to 0 degree and less than 90 degrees, but is not 45 degrees.

It is estimated that the shape of the working fluid passage in a layered body in which metal meshes are layered such that each metal mesh is sequentially rotated in the same direction by a fixed angle as described above is significantly different from the shape of the working fluid passage in a layered body in which metal meshes are layered such that the rotation angle of each metal mesh is 0 degree or an integral multiple of 90 degrees, that is, a layered body in which strand directions of the respective metal meshes are the same (hereinafter, such a layered body may be referred to as a layered body with unrotated layers). In this respect, a detailed description will be given below.

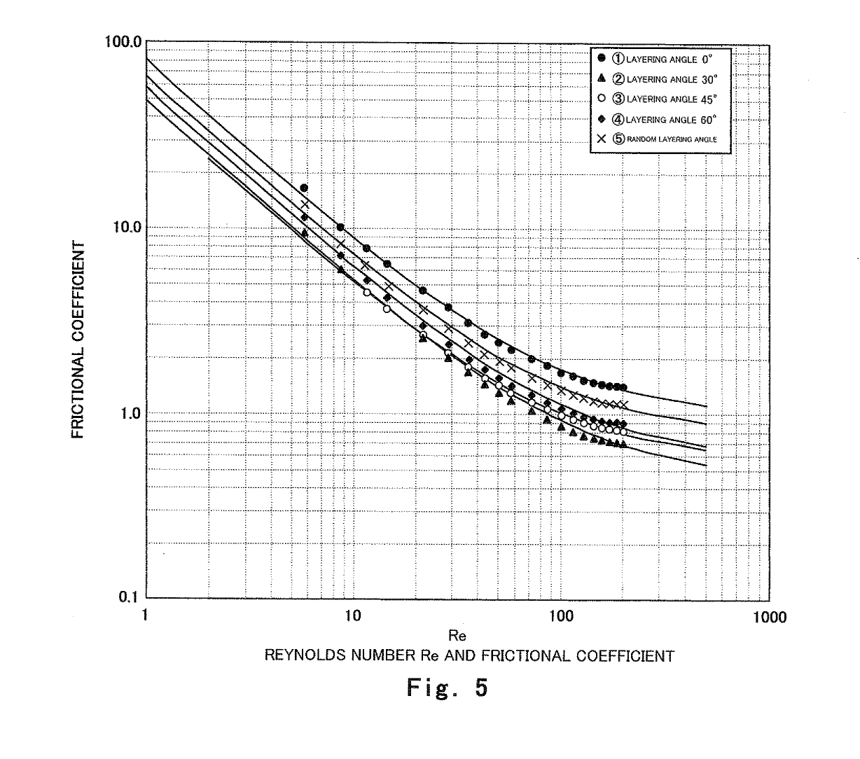

FIG. 5 is a graph showing a comparison of frictional coefficients of respective metal mesh layered bodies with different rotation angles in metal mesh layering. This graph indicates results obtained through a test. The test was conducted by following the steps described in a paper titled “Saiseiki Matorikkusu no Ryudo Sonshitsu (Flow Loss of Regenerator Matrix)” in the Transactions of the Japan Society of Mechanical Engineers (Series B), No. 435 of Vol. 48 (published in November, 1982), pp. 2207-2216.

In the graph, the horizontal axis represents Reynolds number Re and the vertical axis represents each layered body's frictional coefficient f obtained from experimental values. The frictional coefficient f is obtained from Equation 1 below.

$$f = 2 \cdot \frac{Δ P}{ρ \cdot {u}^{2} \cdot N} \qquad [ Equation 1 ]$$

In Equation 1, ΔP represents a pressure loss [Pa] of a fluid flowing through a layered body; ρ represents a density [kg/m³] of the fluid; and u represents an average flow rate [m/sec] of the fluid; and N represents the number of metal meshes 11.

The average flow rate u is obtained from Equation 2 below.

$$u = \frac{{u}_{0}}{β} \qquad [ Equation 2 ]$$

In Equation 2, u₀ represents the average flow rate of the fluid prior to reaching the layered body; β=(L/Pt)²; and L and Pt represent a metal mesh aperture and a metal mesh pitch, respectively, as shown in FIG. 3A. The Reynolds number Re is obtained from Equation 3 below.

$$Re = u \cdot \frac{dm}{μ} \qquad [ Equation 3 ]$$

In Equation 3, dm represents a strand diameter [m] of the metal meshes 11, and μ represents a kinematic viscosity coefficient [m²/sec] of the fluid.

Symbols plotted in the graph indicate measurement values. In the graph, the black circle represents a layered body with the rotation angle of 0 degree; the black up-pointing triangle represents a layered body with the rotation angle of 30 degrees; the white circle represents a layered body with the rotation angle of 45 degrees; the back diamond represents a layered body with the rotation angle of 60 degrees; and the cross represents a layered body in which the rotation angle is not particularly specified and the metal meshes are layered with random rotation angles. Here, the layered body with the rotation angle of 0 degree, and the layered body in which the metal meshes are layered with random rotation angles, are presented as comparative examples.

The specifications of each layered body used in an experiment are as follows:
pitch Pt . . . 0.36 mm
strand diameter dm . . . 0.16 mm
the number of metal meshes . . . 48
material of the metal meshes . . . stainless steel

Conditions of a test fluid used in the experiment are as follows:
fluid type . . . air (steady flow)
fluid temperature . . . ordinary temperature (20° C.±15° C.)
average flow rate u₀ . . . 0.5 to 1.5 m/sec

It is clear from FIG. 5 that in the layered bodies (represented by the black up-pointing triangle, the white circle, and the black diamond) in which the metal meshes are layered such that each metal mesh is sequentially rotated in the same direction by a fixed angle with respect to an immediately previously layered metal mesh, the frictional coefficient f is significantly reduced over the range of all the Reynolds numbers, as compared to the layered body with unrotated layers (represented by the black circle). It is also clear that the frictional coefficient f is reduced over the range of all the Reynolds numbers, as compared to the layered body (represented by the cross) in which the rotation angle is not particularly specified and the metal meshes are layered with random rotation angles.

It is estimated that the reason for the frictional coefficient f of the layered body with unrotated layers to be significantly great is as described below. Specifically, if a strand direction is uniform among all of metal meshes forming a layered body, then the strands of adjacent metal meshes that are arranged one above another are stacked in the longitudinal direction as shown in FIGS. 3B and 3C without crossing each other, or become parallel to each other. In the case of becoming parallel to each other, the strands of the adjacent metal meshes that are arranged one above another are located at the positions of the openings 14 of the metal meshes. This results in blocking the openings 14 to a great degree. In the case where the strands are stacked, reaction of loads exerted at the time of layering the metal meshes cause the strands to push each other in the in-plane direction of the metal meshes. This may result in the metal meshes sliding against each other, causing their strands to be in the aforementioned parallel state. As a result, a situation arises where a large number of openings 14 are blocked to a great degree. In either case, it is considered that the total cross section of the passage is reduced and the frictional coefficient f is significantly increased.

In the layered body in which the rotation angle is not particularly specified and the metal meshes are layered with random rotation angles, a state of 0 degree rotation angle as described above may occur between some metal meshes among a large number of layered metal meshes. Accordingly, there is a high possibility that the passage is blocked at some point.

In contrast, in a case where metal meshes are layered such that each metal mesh is sequentially rotated in the same direction by a fixed angle with respect to an immediately previously layered metal mesh, it is considered that the openings 14 are aligned one above another and thereby a continuous passage is formed.

It has been confirmed from the above test results and examination thereon that a significant advantageous effect, that is, a reduction in frictional coefficient, is obtained in the layered body in which the metal meshes 11 are layered such that each metal mesh 11 is sequentially rotated in the same direction by a fixed angle with respect to an immediately previously layered metal mesh, as compared to the layered body with unrotated layers and the layered body in which the metal meshes 11 are layered at random with no particular rotation angle or the like. It is expected that a similar excellent advantageous effect is obtained not only in cases of rotation angles of 30, 45, and 60 degrees but also in cases of other rotation angles that make a clear rotational displacement, for example, 10, 15, 75, and 80 degrees.

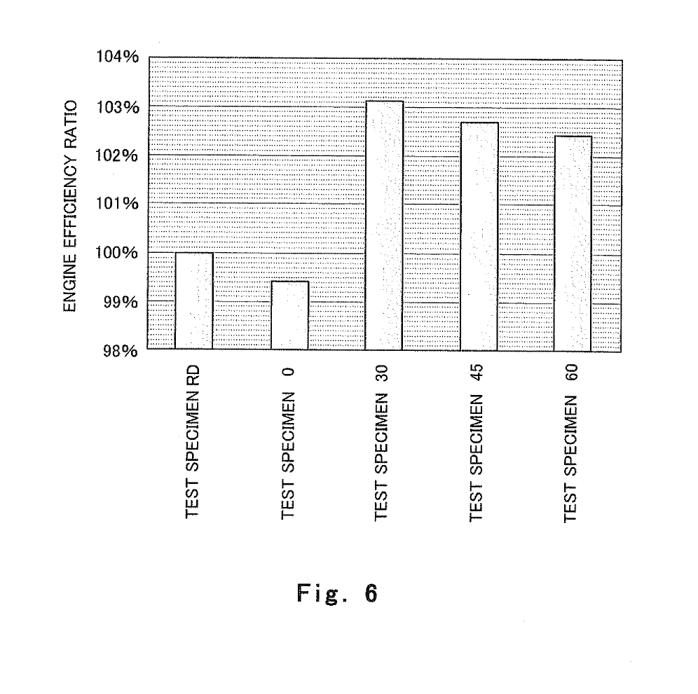

FIG. 6 shows a comparison of engine efficiencies of respective Stirling engines, in which the above-described metal mesh layered bodies of different types are used as regenerators. The engine efficiencies were obtained through numerical calculation based on a description in Chapter 4 of “Sutaaringu Enjin no Riron to Sekkei (Theory and Design of Stirling Engine)” published in Jul. 30, 1999 by SANKAIDO PUBLISHING Co., Ltd. To be specific, Stirling engines of the same type were used in this comparison where the Starling engine that incorporates as a regenerator a layered body with the rotation angle of 0 degree was used as a test specimen 0; the Starling engine that incorporates as a regenerator a layered body with the rotation angle of 30 degrees was used as a test specimen 30; the Starling engine that incorporates as a regenerator a layered body with the rotation angle of 45 degrees was used as a test specimen 45; the Starling engine that incorporates as a regenerator a layered body with the rotation angle of 60 degrees was used as a test specimen 60; and the Starling engine that incorporates as a regenerator a conventional layered body with no particular rotation angle and with random metal mesh layering was used as a test specimen RD. Here, the test specimen 0, and the test specimen RD which is the conventional art, were used as comparative examples.

As is clear from the diagram, when regenerators with different frictional coefficients are used in respective heat engines, engine efficiencies of the respective heat engines significantly vary from each other. The term engine efficiency herein refers to a ratio between input energy to a heat engine and output energy from the heat engine (i.e., output energy divided by input energy). In a case where the engine efficiency of the comparative example test specimen RD was set to 100, the engine efficiency ratio of the test specimen 30 was 103.1; the engine efficiency ratio of the test specimen 45 was 102.7; and the engine efficiency ration of the test specimen 60 was 102.4. In other words, if the test specimens 30, 45, and 60 are used in vehicles such as vessels or automobiles, their fuel consumption (so-called gas mileage) improves by approximately 3% as compared to the comparative example test specimen RD. On the other hand, the engine efficiency of the test specimen 0 was 99.4, which was lower than that of the test specimen RD.

Although in the above-described examples, the regenerator 10 is an annular regenerator. However, the regenerator 10 is not limited to an annular generator but may be a canister-shaped regenerator.

The above-described embodiment gives examples regarding a Stirling engine. However, the present invention is applicable not only to a Stirling engine but also to a regenerator in a boiler for use in thermal power generation, for example. The present invention is further applicable to a regenerator for use in ventilation in the field of air conditioning. In such a regenerator for use in ventilation, heat is exchanged between fresh air and exhaust gas.

### INDUSTRIAL APPLICABILITY

According to the present invention, a passage resistance against a working fluid is reduced even with use of a conventional publicly known metallic mesh material with no other additional components, and also, heat transfer characteristics are improved. Thus, the present invention is also useful as an improvement invention aiming at improving the performance of existing regenerators.

### REFERENCE SIGNS LIST

1 Stirling engine

2 cylinder

3 displacer

4 expansion space

5 power piston

6 compression space

7 chamber

8 pipe

9 heating section

10 regenerator

11 metal mesh

12 cooling section

13 strand

14 opening

110 (metal mesh) layered body

1. A heat engine regenerator, for use in a heat engine, configured to receive and store heat from a high-temperature gas flowing from a high-temperature space into the heat engine regenerator, and to provide the heat to a low-temperature fluid flowing from a low-temperature space into the heat engine regenerator, the heat engine regenerator comprising a large number of layered metallic meshes, wherein
each metallic mesh includes a large number of mutually parallel longitudinal strands and a large number of mutually parallel lateral strands perpendicular to the longitudinal strands, and
the metallic meshes are layered such that each metallic mesh is sequentially rotated in a same direction by a fixed angle with respect to an immediately previously layered metal mesh.

2. The heat engine regenerator according to claim 1, wherein each metallic mesh is round-shaped or annular-shaped.

3. The heat engine regenerator according to claim 1, wherein the metallic meshes are layered such that the longitudinal strands of adjacent metallic meshes that are arranged one above another cross each other and the lateral strands of the adjacent metallic meshes that are arranged one above another cross each other.

4. The heat engine regenerator according to claim 1, wherein the angle is selected in a range from 10 to 80 degrees.

5. The heat engine regenerator according to claim 4, wherein the angle is selected in a range from 30 to 60 degrees.

6. The heat engine regenerator according to claim 5, wherein the angle is one of 30 degrees, 45 degrees, and 60 degrees.

7. A Stirling engine comprising:
an expansion space for a working fluid;
a compression space for the working fluid;
pistons with which the expansion space and the compression space are demarcated; and
a regenerator provided in a fluid passage through which the expansion space and the compression space communicate with each other, wherein
the regenerator is the heat engine regenerator according to claim 1.

8. A Stirling engine comprising:
an expansion space for a working fluid;
a compression space for the working fluid;
pistons with which the expansion space and the compression space are demarcated; and
a regenerator provided in a fluid passage through which the expansion space and the compression space communicate with each other, wherein
the regenerator is the heat engine regenerator according to claim 2.

9. A Stirling engine comprising:
an expansion space for a working fluid;
a compression space for the working fluid;
pistons with which the expansion space and the compression space are demarcated; and
a regenerator provided in a fluid passage through which the expansion space and the compression space communicate with each other, wherein
the regenerator is the heat engine regenerator according to claim 3.

10. A Stirling engine comprising:
an expansion space for a working fluid;
a compression space for the working fluid;
pistons with which the expansion space and the compression space are demarcated; and
a regenerator provided in a fluid passage through which the expansion space and the compression space communicate with each other, wherein
the regenerator is the heat engine regenerator according to claim 4.

11. A Stirling engine comprising:
an expansion space for a working fluid;
a compression space for the working fluid;
pistons with which the expansion space and the compression space are demarcated; and
a regenerator provided in a fluid passage through which the expansion space and the compression space communicate with each other, wherein
the regenerator is the heat engine regenerator according to claim 5.

12. A Stirling engine comprising:
an expansion space for a working fluid;
a compression space for the working fluid;
pistons with which the expansion space and the compression space are demarcated; and
a regenerator provided in a fluid passage through which the expansion space and the compression space communicate with each other, wherein
the regenerator is the heat engine regenerator according to claim 6.
